(19) United States
(12) Patent Application Publication
(10) Pub. No.: US 2005/0238769 A1
(43) Pub. Date: Oct. 27, 2005

(54) Method of producing a packaged product

(75) Inventor: Hendarta Atmadja, Jakarta (ID)

Correspondence Address: INTELLECTUAL PROPERTY LAW GROUP LLP, 12 SOUTH FIRST STREET, SUITE 1205, SAN JOSE, CA, 95113, US

(73) Assignee: Tessa Worldwide PTE. LTD.

(21) Appl. No.: 10/876,937

(22) Filed: Jun. 24, 2004

(30) Foreign Application Priority Data
Apr. 27, 2004 (WO) PCT/SG04/00110

(51) Int. Cl. A23B 4/00

(52) U.S. Cl. 426/394

(57) ABSTRACT

A method of producing tinned coffee is described in which coffee granules 20 are held within a receptacle 16 attached to an end cap 36 of a container 12. The receptacle 16 is provided with a filter 22 to enable a water, sugar solution, milk mixture etc., held within a volume 14 of the container 12 to pass into and out of the receptacle 16 while preventing the coffee granules 20 from escaping the receptacle 16. Coffee is made by heating the sealed container 12 to cause extraction of the coffee from the coffee grounds 20. As the grounds 20 are sealed within the container 12 prior to extraction, all volatile aromatic components of the coffee is retained within the container 12 and infused into the water and milk held therein.

### FIELD OF THE INVENTION

The present invention relates to a method for producing a packaged foodstuff, and in particular a packaged beverage such as, but not limited to, tea or coffee.

### BACKGROUND OF THE INVENTION

The present invention has resulted from the consideration and study of conventional methods of producing packaged foodstuffs particularly packaged drinks.

One known method for making a packaged drink such as coffee is the retort sterilization method. This involves initially placing coffee grounds in an extractor and extracting coffee with water typically at a temperature below 100° C. It is known that during the extraction process some of the volatile aromatic components escape from the coffee extract. Thereafter the coffee extract is filtered to remove coffee grounds and pumped into a vessel to be mixed with other substances and flavourings such as cream and sugar to produce a coffee mixture. The coffee mixture is then pumped and poured into cans which are subsequently sealed. The sealed cans are placed into a steamed pressurized chamber and heated to above 120° C. to kill germs and bacteria so that the coffee mixture becomes sterile and safe for human consumption.

An alternate method is known as the aseptic method which includes extracting and filtering steps substantially the same as the retort sterilization method described above. However once the coffee mixture is obtained in the aseptic method, it is then subjected to an ultrahigh temperature process (UHT) where it is passed through jacketed pipes and heated to above 130° C. for several seconds and then cooled to below 95° C. for a several seconds to kill germs and bacteria and thus become safe for human consumption. Cans and associated caps are separately sterilized in a chamber in which they are steamed and heated to a temperature of above 120° C. The sterilized cans and sterilized coffee mixture are transferred into a specialized filling chamber (an aseptic room) to ensure they do not contact with unsterilized air, where the mixture is then pumped into the sterilized cans which are subsequently capped and sealed.

Both of the above described methods require coffee to be heated (or extracted) before entering the can. As a consequence, a significant proportion of the volatile aromatic components of the coffee are lost prior to the mixture being sealed into the cans. As a result, the canned product lacks the flavour and aromatic components of coffee freshly made from coffee grounds. Several attempts have been made to redress this problem. For example, Canadian patent No. 1,104,409 (Ajinomoto General Foods, Inc.) proposes placing coffee grounds or tealeaves in a small porous sealed bag, placing the sealed bag in a can together with an aqueous sugar solution, tightly closing the can and heating the can under pressure and then rapidly cooling the can. It is believed however that such a product may lack consumer appeal as it would not be aesthetically pleasing to see a filter bag floating in the drink when the can is opened. There is also a possibility that the bag may interfere with the drinking of the drink either by blocking the opening of the can, if consumed directly from the can, or interfering with an end of the straw if consumed with a straw. There also remains a risk that in time the bag may deteriorate to the extent that it fragments so that coffee grounds or tealeaves may escape into the drink.

A further method is described in Japanese patent No. 07-315742 (Tawara Kiko KK). This specification describes a can for making tea or coffee in which is held a supply of water and a container holding tealeaves or coffee powder. The container can be pierced by pressing it against a plurality of projections fixed to a bottom surface of the can. A net or filter is placed across a portion of the container so that once pierced by the projections, water can flow in and out of the container to the exclusion of the coffee powder or tealeaves. In order to consume the drink, the piercing of the container occurs at the time that a consumer wishes to drink the product. At this time, the consumer is also required to heat the product in order to cause extracting and filtering of the coffee or tea from the coffee powder or tealeaves. However, generally, consumers are unable to heat and pressurize the can to fully extract the tea or coffee as would occur in the conventional extraction process.

### SUMMARY OF THE INVENTION

According to one aspect of the present invention there is provided a method of producing a packaged drink comprising: forming an outer container having an opening; forming a receptacle having a plurality of perforations; depositing a volume of a liquid into said outer container through said opening; placing a quantity of particulate drink ingredients in said receptacle, said particulate ingredients and perforations relatively dimensioned so that said particulate ingredient cannot pass through said perforations; and, sealing said receptacle across said opening to close said outer container with said perforations disposed inside said package whereby said liquid can pass into said receptacle through said perforations.

Preferably said forming of said outer container comprises forming an unsealed can having a side wall sealed at one end by a first cap and opened at an opposite end to form said opening. Preferably said method further comprises the step of subjecting said closed outer container to a retort process.

According to a further aspect of the present invention there is provided a method for producing a packaged product comprising a mixture of two or more substances, said method comprising: forming an outer container having an opening; forming a receptacle having a filter forming a portion of a surface of said receptacle; depositing a first substance into said package; placing a second substance in said receptacle; and, attaching said receptacle to said outer container to close said opening with said filter disposed inside said package wherein said first substance is able to move into and out of the receptacle through said filter while said second substance is substantially prevented from moving out of said receptacle by said filter.

Preferably said first substance comprises a liquid. Preferably said second substance comprises a particulate solid. Preferably said package is a can or tin or other container able to withstand a retort process. Preferably said particulate solid comprises an extractable foodstuff. Preferably said particulate solid comprises coffee grounds or tealeaves. Preferably said liquid comprises one of, or a mixture of, water, milk and a sugar solution.

According to a further aspect of the invention there is provided a package for a drink made from a liquid and a particulate solid, said package comprising: an outer container defining a first volume for containing a liquid; and, a receptacle defining a second volume for containing a particulate solid, said receptacle attached to said outer package and provided with a surface portion disposed inside said container, said surface portion comprising a filter configured to allow passage of a liquid between said first and second volumes while substantially preventing the passage of said particulate solid from said second volume to said first volume.

Preferably said outer container is a can having a side wall and first and second end caps sealed across opposite ends of said side wall. Preferably said receptacle is attached to one of first and second end caps on an inside of said can. Preferably said filter comprises a plurality of perforations formed in said surface portion.

### BRIEF DESCRIPTION OF THE DRAWINGS

An embodiment of the present invention will now be described by way of example only with reference to the accompanying drawings in which:

FIG. 1 is an assembly drawing of an embodiment of a package for use in an embodiment of a method for producing a packaged product in accordance with the present invention; and,

FIGS. 2-6 depict sequential steps of the method for producing a packaged product.

### DETAILED DESCRIPTION OF PREFERRED EMBODIMENTS

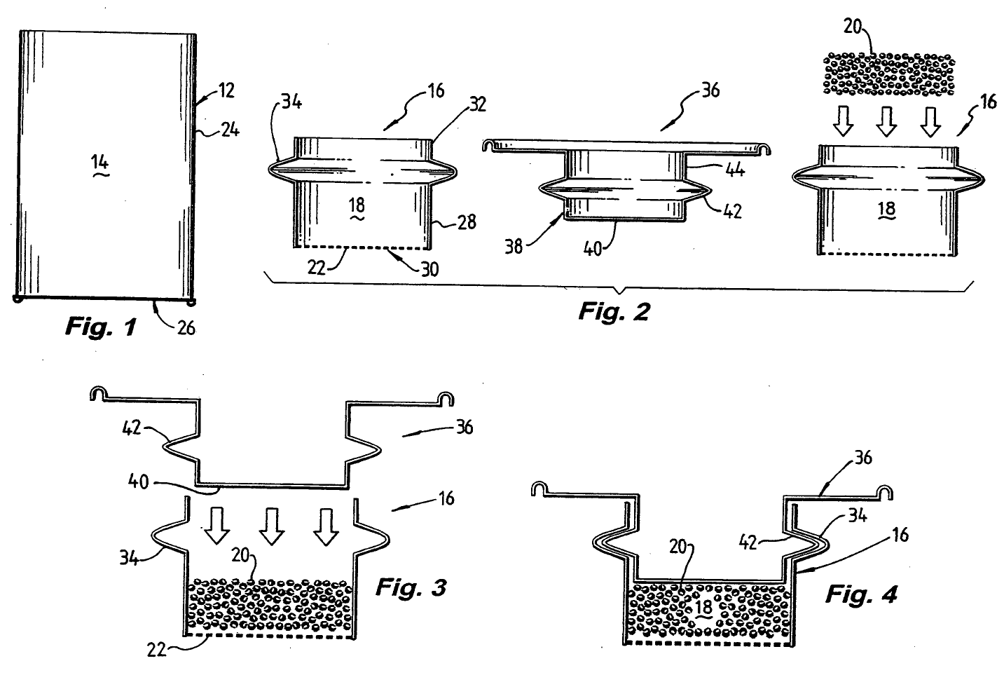

Referring to the accompanying drawings and in particular FIGS. 1 and 6, an embodiment of a package 10 which may be utilized in the present method for producing a packaged drink comprises an outer container 12 defining a volume 14 for containing a first ingredient of the drink, typically in the form of a liquid such as, but not limited to, water, milk, cream or a mixture thereof (not shown) and a receptacle 16 defining a volume 18 which contains a further ingredient of the drink in the form of a particulate solid, in this embodiment depicted as coffee granules 20. A portion of the surface of the receptacle 16 is structured in the form of a filter 22 which is disposed on the inside of the outer container 12 in the assembled package 10. The filter 22 is configured to allow the passage of liquid between the volume 14 and the volume 18 whilst substantially preventing the passage of the coffee grounds 20 from the volume 18 into the volume 14.

The outer container 12 is in the form of a can having a cylindrical side wall 24 and a planar disc-like end cap 26 which is sealed across one end of the side wall 24. Any conventional method and technique may be used to fabricate the cylindrical wall 24 and the end cap 26, and subsequently attach the same to each other.

The receptacle 16 is in the shape of a small circular cup having a substantially cylindrical side wall 28 with a planar base 30 formed at one end. The base 30 is perforated to form the filter 22. The side wall 28 is formed, inboard of its opposite free end 32, with a circumferential groove 34. The groove 34 is of a generally concave cross-section when viewed from inside the volume 18.

The package 10 also includes a second end cap 36. The end cap 36 is formed with a central boss 38 which, in the assembled package 10 projects into the outer container 12. The boss 38 is in a shape substantially complimentary to an inside shape of the receptacle 16 and includes a planar end wall 40 and, a circumferential rib 42 projecting outwardly from a side wall 44 of the boss 38. The rib 42 seats in the groove 34 to effectively couple the receptacle 16 to the end cap 36. The boss 38 is formed of a depth less than the depth of the receptacle 16 so that the volume 18 is effectively limited between the base 30 (i.e. filter 22) of the receptacle 16 and the end wall 40 of the boss 38.

Both the end cap 36 and the receptacle 16 may be made from conventional sheet metal techniques such as cold pressing and deep drawing. The mechanical engagement of the rib 42 in the groove 34 is sufficient to attach the receptacle 16 to the end cap 36. There is no need to provide any supplemental coupling as welding or brazing.

Once the volume 14 has been filled with a prescribed amount of liquid, the coffee granules 20 loaded into the receptacle 16 and, the receptacle 16 attached to the lid 36, the lid 36 can then be sealed across the opposite end of the side wall to complete the manufacture of the package 10.

In broad terms, the above described embodiment of the package 10 facilitates a method for manufacturing a packaged drink such as but not limited to canned tea or coffee utilizing the following major steps. Firstly, the main components of the package 10 shown in FIG. 1 are formed. This comprises forming the outer container 12 which is open at one end, and the receptacle 16. The receptacle 16 is formed with a plurality of perforations in its base 30 to form a filter 22. A mixture of water, milk and/or a sugar solution is poured into the outer container 12 through the open end of the side wall 24.

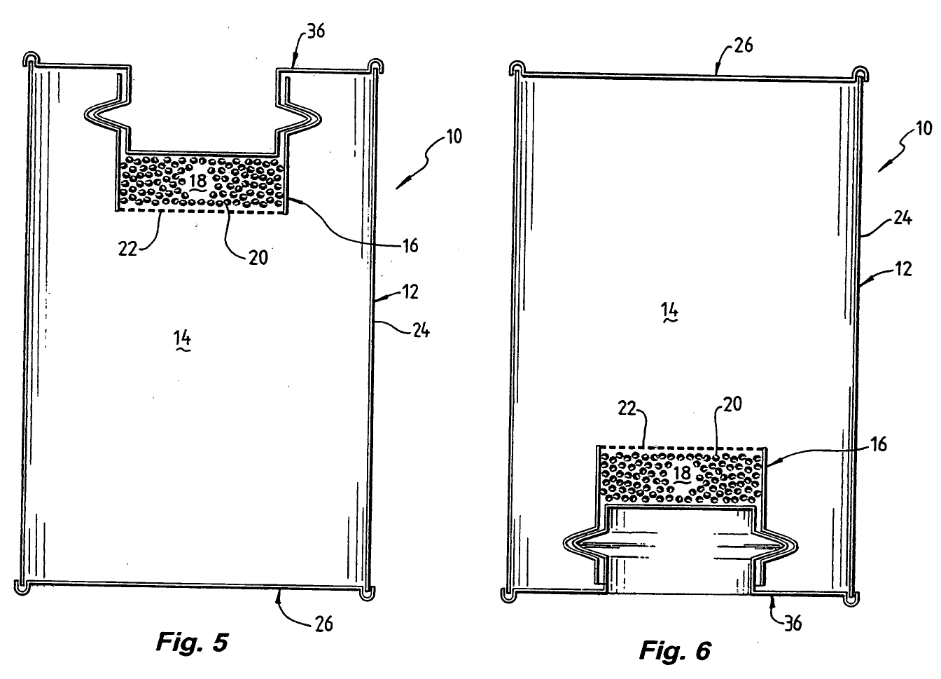

A quantity of coffee granules 20 is deposited in the volume 18 of the receptacle 16 (see FIG. 2). The perforations/filter 22 are configured to allow the liquid within the volume 14 to flow into and out of the volume 18, but prevent the coffee granules from passing from the volume 18 into the volume 14. The receptacle 16 is then sealed across the open end of the container 12. Referring to FIGS. 3-5 this involves pushing the boss 38 into the receptacle 16 so that the rib 42 snaps into the groove 34 then attaching the lid 36 to the side wall 24. The package 10 is now in an inverted state and holds the ingredients for a coffee drink, namely a mixture of water, milk and a sugar solution within the volume 14 and coffee granules 20 within the volume 18.

The package 10 is turned to its upright position, shown in FIG. 6 with the end cap 36 being at the bottom of the package 10. Extraction of coffee from the granules 20 can be performed by the retort method described above namely by placing the package 10 into a steamed pressurized chamber and heating it to above 120° C. This has the dual effect of both extracting coffee from the granules 20 and sterilizing the resulting drink making it safe for human consumption. Optionally the package may be subjected to shaking during extraction.

It should be appreciated that via this method, the extraction process is performed on the granules 20 while they are sealed inside the package 10. Thus all volatile aromatic components are also sealed within the package 10 providing enhanced flavour. It would further be appreciated that the receptacle 16 is fixed to the end cap 36 and thus cannot float within the volume 14. Also, being made from a metal, the receptacle 16 is most unlikely to rupture or burst releasing the coffee granules into the volume 14.

Now that an embodiment of the present invention has been described in detail it will be apparent to those skilled in the relevant arts that numerous modifications and variations may be made without departing from the basic inventive concepts. For example, the above embodiment is described in relation to the making of canned or tinned coffee. However the package and method for producing a packaged product may be applied to other types or forms of drinks or foodstuffs. In particular any foodstuff which can be extracted (“extractable foodstuff”) may be held in the receptacle 16. Most notably, the package and method are well suited for making canned or tinned tea with the coffee granules 20 simply replaced with tealeaves. Further, in the present embodiment the filter 22 is depicted as extending across the base 30 of the receptacle 16. However the filter may be extended up the side wall 28 (i.e. perforations may be formed in the side wall 28). This may promote further flow of liquid through the volume 18 thus enhancing or speeding the extraction process. Indeed it should be appreciated that the entire surface area of the receptacle 16 may be perforated. In addition, while the present embodiment describes the use of a single receptacle 16, multiple receptacles can be provided containing the same or different particulate solids, or solids which dissolve within a liquid. Also, while it is considered most convenient that the receptacle 16 be attached to an end cap of a container, it would be technically possible to form embodiments of the package 10 in a manner so that the receptacle 16 can be attached to an inside of the side wall 24. Also while the package is preferably a tin or can other forms of package, or materials from which the package is formed which can undergo the retort process, may be used.

All such modifications and variations are deemed to be within the scope of the present invention the nature of which is to be determined from the above description and the appended claims.

1. A method of producing a packaged drink comprising:
forming an outer container having an opening;
forming a receptacle having a plurality of perforations;
depositing a volume of a liquid into said outer container through said opening;
placing a quantity of particulate drink ingredients in said receptacle, said particulate ingredients and perforations relatively dimensioned so that said particulate ingredient cannot pass through said perforations; and,
sealing said receptacle across said opening to close said outer container with said perforations disposed inside said package whereby said liquid can pass into said receptacle through said perforations.

2. The method according to claim 1 wherein said forming of said outer container comprises forming an unsealed can having a side wall sealed at one end by a first cap and opened at an opposite end to form said opening.

3. A method of producing a packaged product comprising a mixture of two or more substances, said method comprising:
forming an outer container having an opening;
forming a receptacle having a filter forming a portion of a surface of said receptacle;
placing a second substance in said receptacle; and,
attaching said receptacle to said outer container to close said opening with said filter disposed inside said package wherein a first substance is able to move into and out of the receptacle through said filter while said second substance is substantially prevented from moving out of said receptacle by said filter.

4. The method according to claim 3 wherein said first substance comprises a liquid.

5. The method according to claim 4 wherein said liquid comprises one of, or a mixture of, water, milk and a sugar solution.

6. The method according to any one of claims 3-5 wherein said second substance comprises a particulate solid.

7. The method according to claim 6 wherein said particulate solid comprises an extractable foodstuff.

8. The method according to claim 6 wherein said particulate solids comprises coffee grounds or tealeaves.

9. The method according to claim 6 wherein said package is formed to withstand a retort process.

10. The method according to claim 6 wherein said package is a can or tin.

11. The method according to claim 6 further comprising the step of subjecting said closed outer container to a retort process.

12. A package for a drink made from a liquid and a particulate solid, said package comprising:
an outer container defining a first volume for containing a liquid; and,
a receptacle defining a second volume for containing a particulate solid, said receptacle attached to said outer package and provided with a surface portion disposed inside said container, said surface portion comprising a filter configured to allow passage of a liquid between said first and second volumes while substantially preventing the passage of said particulate solid from said second volume to said first volume.

13. The package according to claim 12 wherein said outer container is a can having a side wall and first and second end caps sealed across opposite ends of said side wall.

14. The package according to claim 13 wherein said receptacle is attached to one of first and second end caps on an inside of said can.

15. The package according to any one of claims 12-14 wherein said filter comprises a plurality of perforations formed in said surface portion.

16. The method according to claim 7 wherein said package is formed to withstand a retort process.

17. The method according to claim 8 wherein said package is formed to withstand a retort process.

18. The method according to claim 7 wherein said package is a can or tin.

19. The method according to claim 8 wherein said package is a can or tin.

20. The method according to claim 9 wherein said package is a can or tin.

21. The method according to claim 16 wherein said package is a can or tin.

22. The method according to claim 17 wherein said package is a can or tin.

23. The method according to claim 7 further comprising the step of subjecting said closed outer container to a retort process.

24. The method according to claim 8 further comprising the step of subjecting said closed outer container to a retort process.

25. The method according to claim 9 further comprising the step of subjecting said closed outer container to a retort process.

26. The method according to claim 16 further comprising the step of subjecting said closed outer container to a retort process.

27. The method according to claim 17 further comprising the step of subjecting said closed outer container to a retort process.

28. The method according to claim 18 further comprising the step of subjecting said closed outer container to a retort process.

29. The method according to claim 19 further comprising the step of subjecting said closed outer container to a retort process.

30. The method according to claim 20 further comprising the step of subjecting said closed outer container to a retort process.

31. The method according to claim 21 further comprising the step of subjecting said closed outer container to a retort process.

32. The method according to claim 22 further comprising the step of subjecting said closed outer container to a retort process.
